(19) United States
(12) Patent Application Publication
(10) Pub. No.: US 2007/0142169 A1
(43) Pub. Date: Jun. 21, 2007

(54) Erroneous sudden acceleration neutralization system and method

(76) Inventor: Jean-Pierre Marcil, Maple Grove (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/304,748

(22) Filed: Dec. 16, 2005

(51) Int. Cl. B60W 10/04

(52) U.S. Cl. 477/107

(57) ABSTRACT

A system for controlling an acceleration of a vehicle, including a control pressure evaluator evaluating a pressure applied on an acceleration control and producing pressure data, at least one sensor producing drive data corresponding to driving conditions of the vehicle, a driver input analyzer characterizing a driver input based on the drive and pressure data and producing a corresponding driver input condition signal, a response evaluator determining a required response based on the driver input condition signal and producing a corresponding response signal, and a controller actuating at least one warning signal and/or reducing a power output of an engine of the vehicle based on the response signal.

### BACKGROUND OF THE INVENTION

1. Field of the Invention

The present invention relates generally to vehicle safety systems, more particularly to a system reacting to erroneous sudden acceleration inputs from a driver.

2. Background Art

It has been determined that, in several sudden acceleration accidents, the driver of the motorized vehicle, in a moment of confusion and/or panic, unknowingly depressed the accelerator pedal, which was mistaken for the brake pedal. In a frantic attempt to stop the vehicle, sudden acceleration can often result in accidents endangering nearby pedestrians. This unintentional actuation of the accelerator pedal instead of the brake pedal of a vehicle is referred to as “Erroneous Sudden Acceleration”.

A first type of Erroneous Sudden Acceleration happens when a driver depressing the brake control also unintentionally depresses the acceleration control in the same motion. The driver thus perceives the engine power against his braking effort, and his/her reaction will be in relation to his/her degree of confidence or fear in the following instants. Confident experienced drivers will generally correct the situation calmly, but less confident or less experienced drivers may in some instance start to panic, especially if the situation is perceived as critical and the vehicle must be quickly immobilized. As a result, the panicked driver may exert high force on either one or both controls at the same time.

A second, generally more severe type of Erroneous Sudden Acceleration happens when a confused and/or panicked driver confuses the brake control with the acceleration control and, in wanting to stop the vehicle, depresses the acceleration control, causing the vehicle to unexpectedly accelerate. This type of error may be the consequence of the driver panicking after the first type of Erroneous Sudden Acceleration described above, but can also happen independently. As the car accelerates, the driver can become frightened and, in wanting to stop the vehicle, can depress the acceleration control (which he/she believes to be the brake control) even further, thus increasing the speed of the vehicle and causing the vehicle to get increasingly out of control.

Erroneous Sudden Acceleration is more likely to occur when a concerned, cautious driver is operating a vehicle at low speed with little or no accelerator input in an area or situation that is perceived by the driver as requiring extra care, skill or caution due to the close proximity of vulnerable pedestrians, especially children. As such, Erroneous Sudden Accelerations have been in many cases the cause of tragic accidents involving injuries to or even death of pedestrians.

As car manufacturers are generally concerned with manufacturing vehicles responding as accurately as possible to a driver's input, vehicles, and particularly cars, are generally not designed to produce a response different than the driver's command input, e.g., stopping when the acceleration control is accidentally depressed. As such, vehicles are usually not equipped to assist an alarmed driver in coping with the problem of Erroneous Sudden Acceleration.

In addition, Erroneous Sudden Acceleration is generally hard to prove and can usually only be supported by testimony of witnesses. In some cases, drivers involved in Erroneous Sudden Acceleration accidents are even under the impression that their vehicle took off “by itself”. As such, an accident caused by Erroneous Sudden Acceleration can easily be mistakenly associated to mechanical failure, which can cause the vehicle's manufacturer to be wrongly identified as liable for the accident.

### SUMMARY OF INVENTION

It is therefore an aim of the present invention to provide a system for controlling an acceleration of a vehicle which identifies Erroneous Sudden Accelerations and reacts accordingly.

It is a further aim of the present invention to provide a system to warn and/or provide assistance to the driver of a vehicle which identified Erroneous Sudden Acceleration and reacts accordingly.

Therefore, in accordance with the present invention, there is provided a system for controlling an acceleration of a vehicle, the system comprising: a control pressure evaluator associated with an acceleration control of the vehicle so as to evaluate a pressure applied on the acceleration control of the vehicle and produce corresponding pressure data; at least one sensor producing drive data corresponding to driving conditions of the vehicle; a driver input analyzer associated with the control pressure evaluator and the at least one sensor, the driver input analyzer characterizing a driver input of the vehicle based on the drive data and the pressure data and producing a corresponding driver input condition signal; a response evaluator connected to the driver input analyzer and determining a required response based on the driver input condition signal and producing a corresponding response signal; and a controller connected to the response evaluator and actuating at least one warning signal and/or reducing a power output of an engine of the vehicle based on the response signal.

Further in accordance with the present invention, there is provided a method for neutralizing an erroneous sudden acceleration in a vehicle, the method comprising the steps of: a) evaluating a pressure applied on an acceleration control of the vehicle; b) characterizing driving conditions of the vehicle; c) recognizing one of a presence and absence of the erroneous sudden acceleration, based on the pressure on the acceleration control and driving conditions of the vehicle; and d) actuating at least one warning signal and/or reducing a power output of an engine of the vehicle when the erroneous sudden acceleration is present.

Still further in accordance with the present invention, there is provided a method for neutralizing an erroneous sudden acceleration of a vehicle, the method comprising the steps of: a) evaluating a position of acceleration and brake controls of the vehicle; b) measuring a speed of the vehicle; c) recognizing one of a presence and an absence of the erroneous sudden acceleration, based on the position of the acceleration and brake controls and on the speed of the vehicle; d) actuating at least one warning signal and/or reducing a power output of an engine of the vehicle when the erroneous sudden acceleration is present.

### BRIEF DESCRIPTION OF THE DRAWINGS

Having thus generally described the nature of the invention, reference will now be made to the accompanying drawings, showing by way of illustration a particular embodiment thereof and in which:

FIG. 1 is a schematic representation of a vehicle and an Erroneous Sudden Acceleration neutralization system according to one embodiment of the present invention;

FIG. 2 is a flow chart showing an example of the operations performed by the system of FIG. 1;

FIG. 3 is a flow chart showing an example of the operations performed by a driver input analyzer of the system of FIG. 1;

FIG. 4 is a flow chart showing an example of the operations performed by a response evaluator of the system of FIG. 1; and

FIG. 5 is a graphical representation of the resistance as a function of the angular position of an acceleration control of a vehicle equipped with the system of FIG. 1.

### DESCRIPTION OF PARTICULAR EMBODIMENTS

In a motorized vehicle, particularly in a car or truck, the braking power or resistance provided by the braking system is usually in relation with the pressure applied to the brake pedal/control. The more pressure is applied, the harder the vehicle brakes. It has been shown that drivers are generally prone to exert excessive pressure to the brake pedal in emergency situations.

The acceleration control or pedal, on the other hand, generally provides control of the engine power via a light even resistance throughout the travel range of the accelerator control. As such, the amount of power output desired by the driver is usually in relation to the angle or position of the pedal/control, and not in function of the magnitude of the pressure applied thereon by the driver. One exception is the usual presence of a kick-down switch at the end of the travel of the acceleration pedal/control, which corresponds to wide open throttle (WOT) and may require a slight pressure increase to be depressed. However, this increased pressure is generally only a fraction of the force exerted on the brake pedal/control by a driver in a state of panic.

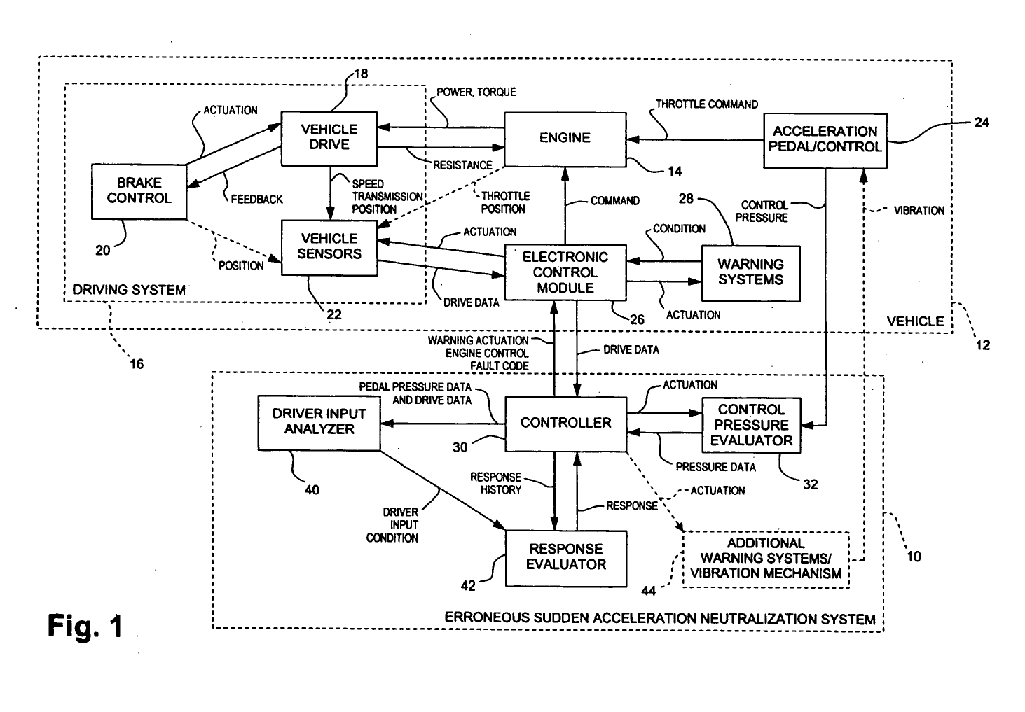

As such, an Erroneous Sudden Acceleration neutralization system 10 as illustrated in FIG. 1 is based on the assumption that a driver would not normally need to exert excessive pressure on the acceleration pedal/control, and as such interprets such an excessive pressure as an Erroneous Sudden Acceleration caused by a confused driver input and acts accordingly.

The system 10 provides a simple and cost effective means to assist a driver when, in a moment of confusion and/or panic, Erroneous Sudden Acceleration is caused by mistakenly depressing the acceleration pedal/control instead of the brake pedal/control when wanting to stop the vehicle, or by depressing both pedals/controls at the same time while driving at a given speed. The system 10 may also provide warning to nearby pedestrians so that they may have time to move out of the way of the out-of-control vehicle, thus reducing the chance that a pedestrian will be struck by the vehicle 12.

Referring to FIG. 1, the Erroneous Sudden Acceleration neutralization system 10 is adapted to be used with a vehicle 12, which can be for example a car or a truck. The vehicle 12 generally comprises an engine 14 which supplies power and torque to a driving system 16, particularly to a vehicle drive 18 including for example wheels, transmission system, driving shaft, etc., as well as a brake system.

The driving system 16 also includes a brake control 20, which is usually in the form of a pedal depressed by a driver of the vehicle 12. The depressed brake control 20 actuates the braking system of the vehicle drive 18 which provides resistance to slow down the vehicle 12.

The driving system 16 also generally includes vehicle sensors 22 which measure the speed of the vehicle 12 and the position of the transmission (e.g., “drive”, “reverse” or “neutral”) from the vehicle drive 18, the throttle position or other indication of the power of the engine 14, and which can also measure the position of the brake control 20. In a particular embodiment, the vehicle sensors 22 include a drive switch which is actuated when the transmission is engaged in “drive”, a reverse switch which is actuated when the transmission is engaged in “reverse”, a speed sensor measuring the speed of the vehicle 12, a brake switch which is actuated when the brake control 20 is depressed, and a throttle position sensor measuring the position of the throttle of the engine 14. Other types of sensors are also possible.

The vehicle 12 also comprises an acceleration control 24 which is usually in the form of a pedal depressed by the driver of the vehicle 12 to actuate the opening and closing of the throttle of the engine 14 such as to vary the acceleration of the vehicle 12. Other types of acceleration and brake controls 24,20 can alternately be used, including, but not limited to, hand-actuated controls.

The vehicle 12 further comprises an electronic control module 26 which regulates the operation of the engine 14 to optimize performances. The control module 26 also actuates the vehicle sensors 22 and receives drive data therefrom, including data on the speed of the vehicle 12, the position of the transmission, the position of the throttle, and the position of the brake control 20.

The control module 26 further actuates warning systems 28, some automatically and others upon an appropriate command of the driver. The warning systems 28 can include typical interfaces present in a vehicle, for example lights on the dashboard of the vehicle and various warning sound producing devices, but also systems that have other purposes in addition to being usable as warning systems, for example a horn of the vehicle, headlights, etc.

Still referring to FIG. 1, the Erroneous Sudden Acceleration neutralization system 10 comprises a controller 30 which receives drive data from the electronic control module 26 of the vehicle 12. The system 10 also includes a control pressure evaluator 32, which is actuated by the controller 30 to measure the pressure applied on the acceleration control 24 and communicate pressure data to the controller 30 accordingly.

In a particular embodiment, the control pressure evaluator 32 comprises a sensor incorporated within the mechanism of the acceleration control 24. The sensor can be for example an electrical switch which is triggered by a given pressure on the acceleration control 24, with the given pressure being considerably greater than the pressure required to actuate the Wide Open Throttle switch at the end of the travel of the acceleration control 24. Such an electrical switch can be installed in parallel with the throttle mechanisms.

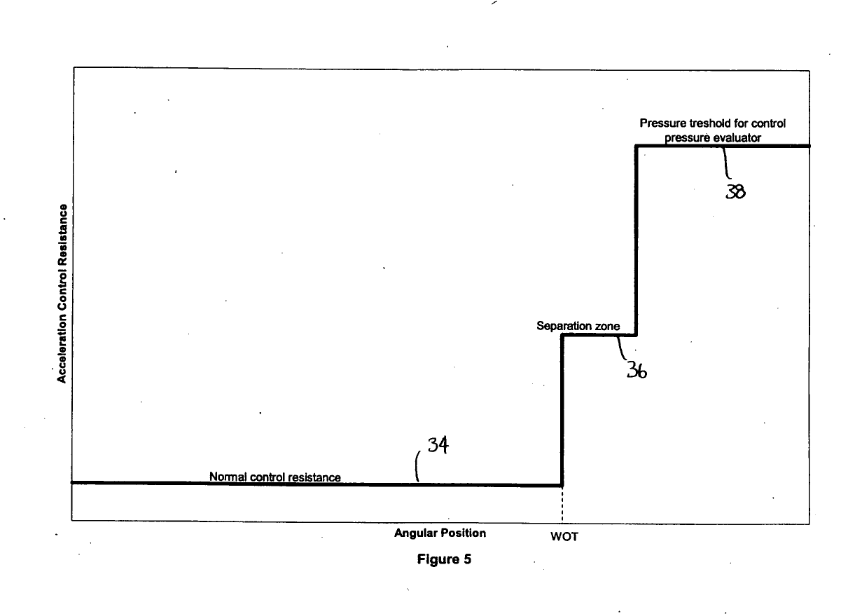

Thus, and as shown in FIG. 5, the driver would distinguish three distinct levels or steps of resistance when depressing the acceleration control 24: a first level of resistance 34 from idle to Wide Open Throttle, corresponding to a usual acceleration control resistance, a second level of resistance 36, corresponding to the resistance of the Wide Open Throttle Switch and indicating a transition zone marking the effective end of the acceleration control travel, and a third level of resistance 38, corresponding to the actuation of the electrical switch of the control pressure evaluator 32. The second level of resistance 36 can be approximately five (5) times the first level of resistance 34, while the third level of resistance 38 can be approximately ten (10) times the first level of resistance 34. Thus, in this example the driver would need to apply ten times the usual pressure to the acceleration control 24 to actuate the switch of the control pressure evaluator 32, which is unlikely to happen during normal operation of the vehicle 12, thus reducing the risk of the system 10 acting on the vehicle 12 when it is not necessary.

It is pointed out that both the second level 36 and the third level 38 are illustrated in FIG. 5 as being associated with varying angular positions of the acceleration control 24. However, both levels 36 and 38 could be for a same maximal angular position of the acceleration control 24. In such a case, alternative forms are also possible for the control pressure evaluator 32, for example a sensor such as a transducer effectively measuring the pressure applied to the acceleration control 24 and comparing the measured pressure to a given threshold.

The system 10 also comprises a driver input analyzer 40 receiving the pedal pressure data and the drive data from the controller 30, determining the driver input condition, and producing a driver input condition signal accordingly. The driver input analyzer 40 characterizes the driver input as being confused when one of the cases of Erroneous Sudden Acceleration is identified.

As excessive pressure on the acceleration control 24 is in itself generally not dangerous if the vehicle 12 is not in movement, the driver input analyzer 40 can use, for example, the transmission position and/or the vehicle speed from the drive data to determine if the vehicle 12 is moving. The driver input analyzer 40, upon identifying movement of the vehicle 12 combined with excessive pressure on the acceleration control 24 as indicated by the pressure data, produces a driver input condition signal identifying the driver input as confused, i.e., the case of an Erroneous Sudden Acceleration.

Similarly, depressing both the acceleration and brake controls 24,20 at the same time can be intentional when the vehicle 12 moves at a low speed, for example in a steep incline to prevent the vehicle from rolling downhill. The driver input analyzer 40 will thus evaluate the speed of the vehicle 12 from the drive data and, if the speed is above a set threshold, and the drive data indicates that both acceleration and brake control 24,20 are being depressed simultaneously, the driver input analyzer 40 produces a driver input condition signal identifying the driver input as confused, i.e., the case of an Erroneous Sudden Acceleration.

The system 10 further comprises a response evaluator 42 receiving the driver input condition signal from the driver input analyzer 40 and receiving data on the response history of the system 10 from the controller 30, e.g., whether the system 10 has acted or not on the vehicle 12 due to an Erroneous Sudden Acceleration during a given time period. Alternately, the response evaluator 42 can include memory means (e.g., a database or like storage) to store data on the previous response signals given, thus eliminating the need for the response history data to be sent by the controller 30. The response evaluator 42 then produces a response signal according to the response history data and the driver input condition signal. The response evaluator 42 thus allows the system 10 to react incrementally to the Erroneous Sudden Acceleration detected, for example by indicating through the first occurrence of the response signal for a given time period that a warning to the driver is required and through a later occurrence of the response signal for the given time period that a more aggressive warning to the driver is required or that the engine power should be reduced. This incremental response allows the driver to regain control of the vehicle 12 before the more active responses are performed. Alternately, the response history data can be omitted, in which case the response evaluator 42 produces the same response signal for every occurrence of the confused driver input condition signal.

The controller 30 receives the response signal from the response evaluator 42 and sends an actuation signal based on the response signal to the electronic control module 26 instructing it with the actions to be performed on the vehicle 12. Such actions can include the actuation of the warning systems 28, the reduction of the power output of the engine 14, for example by cutting off a pre-selected group of injectors or/and by retarding the timing, the recordation of a fault code in the memory of the electronic control module 26, etc.

Additional warning systems 44 can optionally be installed in the vehicle 12, and are also actuated by the controller 30 upon reception of the proper response signal from the response evaluator 42. The additional warning systems 44 can include, for example, a special siren or chime sounding inside and/or outside of the vehicle 12, one or a series of LEDS on the dashboard of the vehicle 12, a lighting system over the brake and acceleration controls 20,24 of the vehicle 12, etc. The additional warning systems 44 can also include an acceleration control vibration mechanism which can be, for example, an electrical motor fitted with an unbalanced weight and attached to the acceleration control 24, thus vibrating the acceleration control 24 in a similar although stronger manner as vibration mechanisms commonly used to vibrate video game controls.

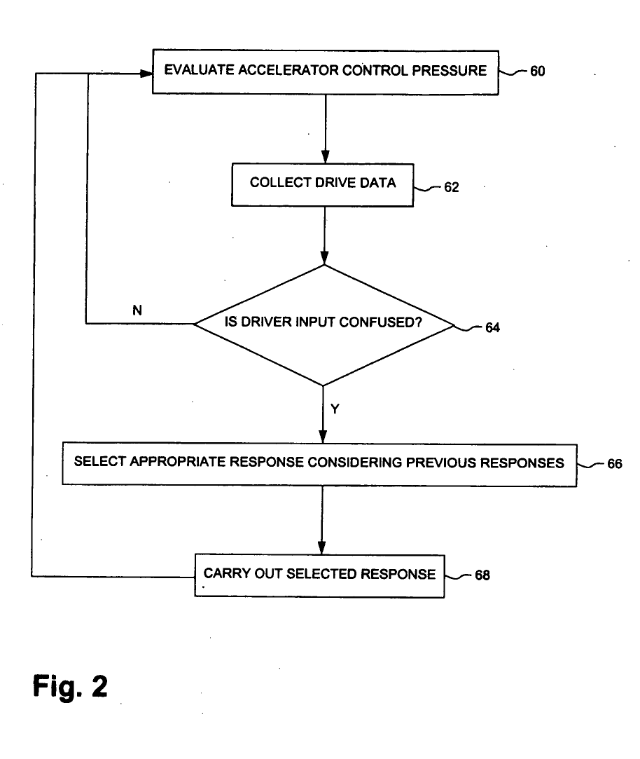

In use, and referring to FIG. 2 which shows an example of the process that can be carried out by the system 10, the system 10 first evaluates the acceleration control pressure through the control pressure evaluator 32 as indicated in step 60. The controller 30 collects drive data from the electronic control module 26 of the vehicle 12 as indicated in step 62, the electronic control module 26 having received the data from the vehicle sensors 22. The driver input analyzer 40, receiving the pressure and drive data from the controller 30, evaluates if the driver input is confused, as indicated in step 64, and sends a driver input condition signal accordingly. If the driver input is not confused, the system 10 goes back to the beginning of the process (step 60). If the driver input is confused, the response evaluator 42 receiving the confused driver input condition signal selects an appropriate response, for example based on the response history, as indicated in step 66, and sends a response signal accordingly. The controller 30, upon reception of the response signal, carries out the selected response, as indicated in step 68. The system 10 then goes back to evaluating the acceleration control pressure through the control pressure evaluator 32 (step 60).

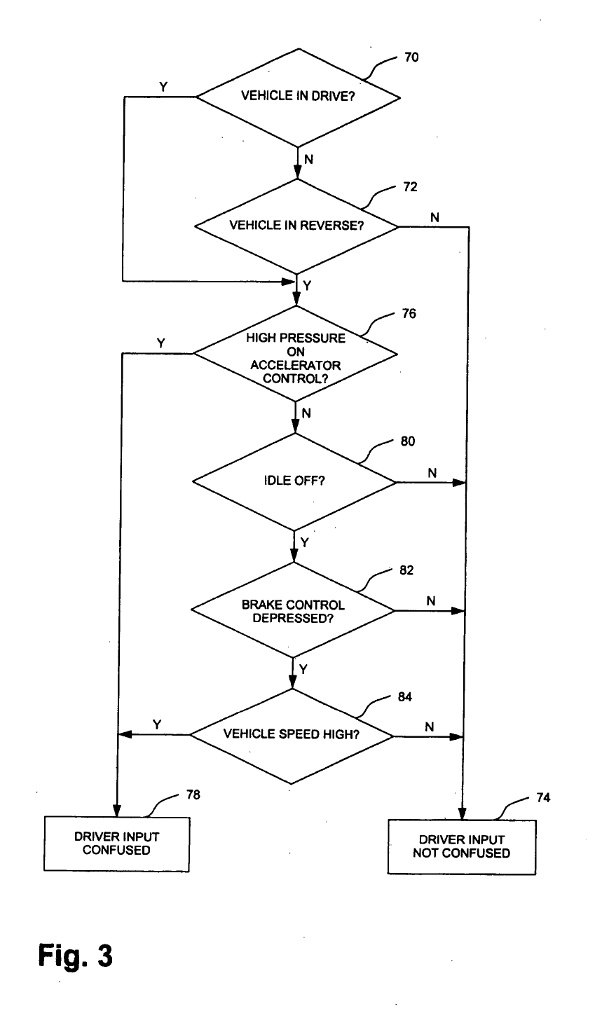

FIG. 3 shows an example of the process carried out by the driver input analyzer 40 in step 64 of FIG. 2. The driver input analyzer 40 first evaluates if the vehicle is engaged in “drive” from the transmission position, as indicated in step 70. If not, the analyzer 40 determines if the vehicle in engaged in “reverse” from the transmission position, as indicated in step 72. If not, the driver input will have no effect on the vehicle 12 as the transmission is not engaged, and as such the driver input is characterized as not confused, as indicated in step 74.

If the vehicle is either in “drive” (step 70) or in “reverse” (step 72), the driver input analyzer 40 first determines if an Erroneous Sudden Acceleration resulting from depressing the acceleration control 24 instead of the brake control 20 is present. The analyzer 40 thus determines from the pressure data if there is a high pressure on the acceleration control 24, as indicated in step 76. If yes, the Erroneous Sudden Acceleration is present, and the driver input is characterized as confused, as indicated in step 78.

If there is no high pressure on the acceleration control 24 (step 76), the driver input analyzer 40 can determine if the Erroneous Sudden Acceleration resulting from both the acceleration and brake controls 24,20 being depressed together is present. The analyzer 40 first determines from the drive data if the vehicle 12 is off from idle, i.e., if the acceleration control 24 is depressed, as indicated in step 80. If so, the analyzer 40 then determines from the drive data if the brake control 20 is depressed, as indicated in step 82. If so, the analyzer further determines from the drive data if the vehicle speed is above a given threshold, as indicated in step 84. If the speed is above the given threshold (step 84), Erroneous Sudden Acceleration is present, and the driver input is characterized as confused (step 78). If the idle is not off (i.e., the acceleration control 24 is not depressed) (step 80), or the brake control 20 is not depressed (step 82), or the vehicle speed is not above the given threshold (step 84), then there is no Erroneous Sudden Acceleration and the driver input is characterized as not confused (step 74).

In cases where the control pressure evaluator 32 is able to measure the pressure applied on the acceleration control 24 (i.e., as opposed to a switch actuated only when excessive pressure is applied), step 80 can alternately be performed by determining if pressure is applied on the acceleration control 24 through the pressure data. Alternately, steps 80,82 and 84 can be omitted, such that the driver input analyzer is able to recognize only the most dangerous type of Erroneous Sudden Acceleration, i.e., Erroneous Sudden Acceleration resulting from depressing the acceleration control 24 instead of the brake control 20.

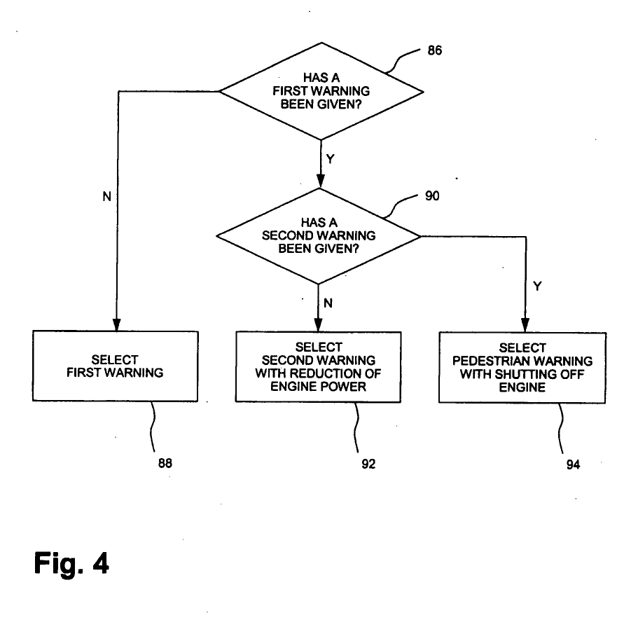

FIG. 4 shows an example of the process carried out by the response evaluator 42 in step 66 of FIG. 2. The response evaluator 42 determines from the response history data if a first warning has been given during a set time period, as indicated in step 86. If not, the response evaluator 42 selects the first warning as an appropriate response, as indicated in step 88, and sends the response signal accordingly. Such a first warning is usually intended to get the attention of the driver on the Erroneous Sudden Acceleration in such a way that the error can be recognized while avoiding panic, for example through actuation of some of the warning systems 28,44 directed toward the interior of the vehicle 12, e.g., the lighting/blinking of a visual signal such as a LED in the dashboard of the vehicle 12, the actuation of a chime or other warning sound producing device, etc. Along with the first warning, the response evaluator 42 instructs the controller 30 through the response signal to keep a record of the first warning being given in any type of appropriate memory means, for example by registering a fault code in a memory of the electronic control module 26 of the vehicle 12.

If a first warning has already been given during the set time period (step 86), the response evaluator 42 determines if a second warning has been given during the set time period, as indicated in step 90. If not, the response evaluator 42 selects the second warning as an appropriate response, as indicated in step 92, and send the response signal accordingly. The response signal corresponding to the second warning can also include instructions to the controller 30 to carry out corrective measures on the vehicle 12. The second warning could be, for example, silencing or changing the warning sound, varying the blinking of the LED or lighting/blinking another LED, vibrating the acceleration control 24, etc. Corrective measures could include, for example, substantially reducing the power output of the engine 14 by cutting off a pre-selected group of injector or/and by retarding the timing of the engine 14. Along with the second warning, the response evaluator 42 can instruct the controller 30 through the response signal to keep a record of the second warning being given in any type of appropriate memory means, for example by registering a second fault code in the memory of the electronic control module 26 of the vehicle 12.

If a second warning has already been given during the set time period (step 90), the response evaluator 42 selects the third warning as an appropriate response, as indicated in step 94, and sends the response signal accordingly. The response signal corresponding to the third warning can also include instructions to the controller 30 to carry out further corrective measures on the vehicle 12. The third warning could be for example more oriented toward warning pedestrians around the vehicle, and as such include actuating some of the warning systems 28,44 more directed to the exterior environment of the vehicle 12, for example triggering the horn of the vehicle 12, blinking the headlights, etc. The further corrective measures could include, for example, further reducing the engine power or even shutting down the engine. Along with the third warning, the response evaluator 42 can instruct the controller 30 through the response signal to keep a record of the third warning being given in any type of appropriate memory means, for example by registering a third fault code in the memory of the electronic control module 26 of the vehicle 12.

If at any time after the first, second or third warning, the driver regains control of the vehicle, the Erroneous Sudden Acceleration will no longer be present, and as such the driver input analyzer 40 will no longer identify the driver input as being confused. Thus, normal drivability of the vehicle 12 is resumed. Alternately, and especially in the case of the third warning, the response signal sent by the response evaluator 42 can include instructions to maintain the reduced engine power until, for example, the engine is shut off and restarted.

When the response signal of the response evaluator 42 is based on response history data, the system 10 provides an incremental response which allows the driver at least one chance to regain control of the vehicle 12 before taking action to slow down the vehicle 12.

In addition, the fault codes registered in the electronic control module 26 of the vehicle 12 at each step of the intervention of the system 10 can provide proof that Erroneous Sudden Acceleration occurred, which can serve to better identify the cause of an accident and as such exonerate the vehicle's manufacturer when appropriate.

Because the control pressure evaluator 32 reacts to an excessive, generally panic-induced pressure which is substantially greater than a normal, wide-open throttle acceleration pressure, the system 10 can thus distinguish between normal use of the acceleration control 24 and Erroneous Sudden Accelerations, and can thus warn the driver and/or counter the Erroneous Sudden Accelerations without impeding the normal use of the acceleration control 24.

The embodiments of the invention described above are intended to be exemplary. Those skilled in the art will therefore appreciate that the foregoing description is illustrative only, and that various alternatives and modifications can be devised without departing from the spirit of the present invention. Accordingly, the present invention is intended to embrace all such alternatives, modifications and variances which fall within the scope of the appended claims.

I claim:

1. A system for controlling an acceleration of a vehicle, the system comprising:
a control pressure evaluator associated with an acceleration control of the vehicle so as to evaluate a pressure applied on the acceleration control of the vehicle and produce corresponding pressure data;
at least one sensor producing drive data corresponding to driving conditions of the vehicle;
a driver input analyzer associated with the control pressure evaluator and the at least one sensor, the driver input analyzer characterizing a driver input of the vehicle based on the drive data and the pressure data and producing a corresponding driver input condition signal;
a response evaluator connected to the driver input analyzer and determining a required response based on the driver input condition signal and producing a corresponding response signal; and
a controller connected to the response evaluator and actuating at least one warning signal and/or reducing a power output of an engine of the vehicle based on the response signal.

2. The system according to claim 1, wherein the driver input condition signal is one of a confused signal and a normal signal, and the response evaluator produces the response signal upon reception of the confused signal.

3. The 'system according to claim 2, wherein the driver input analyzer produces the confused signal when the pressure data is above a given pressure threshold and the drive data indicates that the vehicle is in movement.

4. The system according to claim 2, wherein the driver input analyzer produces the confused signal when the drive data indicates simultaneous actuation of the acceleration control and of a brake control of the vehicle while the vehicle is moving at a speed above a given speed threshold.

5. The system according to claim 1, wherein the response evaluator determines the required response also based on response history data of the system for a given time period.

6. The system according to claim 5, wherein the response evaluator includes a database for storing the response history data.

7. The system according to claim 5, wherein a first occurrence of the response signal during the given time period instructs the controller to actuate the at least one warning signal, and a later occurrence of the response signal during the given time period instructs the controller to reduce the power output of the engine.

8. The system according to claim 1, wherein the at least one sensor includes a brake sensor evaluating a position of a brake control of the vehicle, a speed sensor measuring a speed of the vehicle, and a transmission sensor determining a position of a transmission of the vehicle.

9. The system according to claim 1, wherein the at least one warning signal includes at least one of a horn of the vehicle, lights within the vehicle, a warning sound producing device, headlights of the vehicle, and a vibration mechanism vibrating the acceleration control.

10. The system according to claim 1, wherein the controller sends an actuation signal based on the response signal to an electronic control module of the vehicle, the actuation signal containing instructions to actuate the at least one warning signal and/or reduce the power output of the engine.

11. The system according to claim 10, wherein the actuation signal also contains instructions to register a fault code in a memory of the electronic control module.

12. The system according to claim 1, wherein the control pressure evaluator is a pressure sensitive switch which is activated when the acceleration control of the vehicle is depressed with a pressure at least equal to a pressure threshold.

13. A method for neutralizing an erroneous sudden acceleration in a vehicle, the method comprising the steps of:
a) evaluating a pressure applied on an acceleration control of the vehicle;
b) characterizing driving conditions of the vehicle;
c) recognizing one of a presence and absence of the erroneous sudden acceleration, based on the pressure on the acceleration control and driving conditions of the vehicle; and
d) actuating at least one warning signal and/or reducing a power output of an engine of the vehicle when the erroneous sudden acceleration is present.

14. The method according to claim 13, wherein step c) further comprises storing response history data on the presence of the erroneous sudden acceleration.

15. The method according to claim 14, wherein step c) further comprises considering the response history data in actuating at least one warning signal and/or reducing a power output of an engine of the vehicle when the erroneous sudden acceleration is present.

16. The method according to claim 13, wherein in step b), the driving conditions of the vehicle are characterized by at least one of evaluating a position of a brake control of the vehicle, evaluating a position of the acceleration control of the vehicle, measuring a speed of the vehicle, and determining a position of a transmission of the vehicle.

17. The method according to claim 13, wherein actuating the at least one warning signal includes at least one of actuating a horn of the vehicle, turning lights on within the vehicle, producing a warning sound, blinking headlights of the vehicle, and vibrating the acceleration control.

18. The method according to claim 13, wherein in step d) the at least one warning signal is actuated by sending an actuation signal to an electronic control module of the vehicle, which in turn actuates the at least one warning signal.

19. A method for neutralizing an erroneous sudden acceleration of a vehicle, the method comprising the steps of:
a) evaluating a position of acceleration and brake controls of the vehicle;
b) measuring a speed of the vehicle;
c) recognizing one of a presence and an absence of the erroneous sudden acceleration, based on the position of the acceleration and brake controls and on the speed of the vehicle;
d) actuating at least one warning signal and/or reducing a power output of an engine of the vehicle when the erroneous sudden acceleration is present.
